(19) United States
(12) Patent Application Publication
(10) Pub. No.: US 2019/0038079 A1
(43) Pub. Date: Feb. 7, 2019

(54) CONTAINER

(71) Applicant: Keri Lee Ingram, Fort White, FL (US)

(72) Inventor: Keri Lee Ingram, Fort White, FL (US)

(21) Appl. No.: 15/665,507

(22) Filed: Aug. 1, 2017

(51) Int. Cl. A47J 43/18; B26B 29/06

(52) U.S. Cl. CPC A47J 43/18; B65D 25/04; B26B 29/063

(57) ABSTRACT

A container having one or more sections, wherein each of the one or more sections are defined by a bottom surface having one or more sidewalls extending upward from the bottom surface, wherein an upper perimeter of the one or more sidewalls is irregularly shaped.

### CROSS-REFERENCE TO RELATED APPLICATION(S)

Not applicable

### BACKGROUND OF THE INVENTION

### 1. Field of Invention

The present invention relates to the field of container and more particularly to multi-functional containers.

### 2. Description of Related Art

Food preparation includes physical modification of the food for cooking or segmenting larger portions into edible pieces. The food is then cooked and presented for consumption. One of the standard modifications involves cutting the food into smaller portions to be easily eaten.

Traditionally, this involved placing of the food onto a surface designed to be cut. The material of the surface is generally resistant to cutting or tearing. Synthetic plastics or organic materials such as wood make for a good cutting surface. The cut food is then transferred to a separate dish for serving. The transfer of food was required for presentation purposes and the presentation container is generally not resistant to cutting. That is, the material of the presentation dish has a finish that it delicate and subject to physical damage.

Based on the foregoing, there is a need in the art for a multifunctional container that will allow for a plurality of uses beyond simple presentation. A modified container allowing for cutting and presentation in a single container.

### SUMMARY OF THE INVENTION

A container having one or more sections, wherein each of the one or more sections are defined by a bottom surface having one or more sidewalls extending upward from the bottom surface, wherein an upper perimeter of the one or more sidewalls is irregularly shaped.

In an embodiment, the container further comprises at least two sections, wherein the at least two sections are separated by a shared sidewall.

In an embodiment, the one or more sections are releasably engaged with one another, wherein the shared sidewall is configured to bisect along a longitudinal axis.

In an embodiment, two sections of the shared sidewall releasably attach to one another using one or more magnets disposed within each of the two sections.

In an embodiment, the irregular shape is generally V-shaped, wherein a trough of the V-shape is proximal to the bottom surface.

In an embodiment, the V-shape is configured to facilitate a blade of a knife entering an interior of the container.

In an embodiment, each of the one or more sidewalls have a plurality of V-shape irregularities disposed at predetermined intervals of upper perimeter of each of the one or more sidewalls.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is a perspective view of the container, according to an embodiment of the present invention;

FIG. 2 is a top plan view of the container, according to an embodiment of the present invention.

### DETAILED DESCRIPTION OF PREFERRED EMBODIMENTS

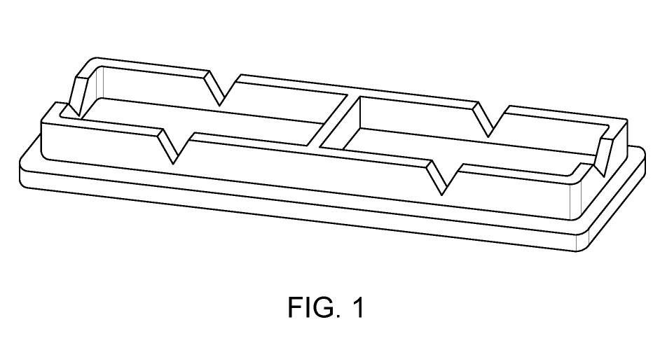

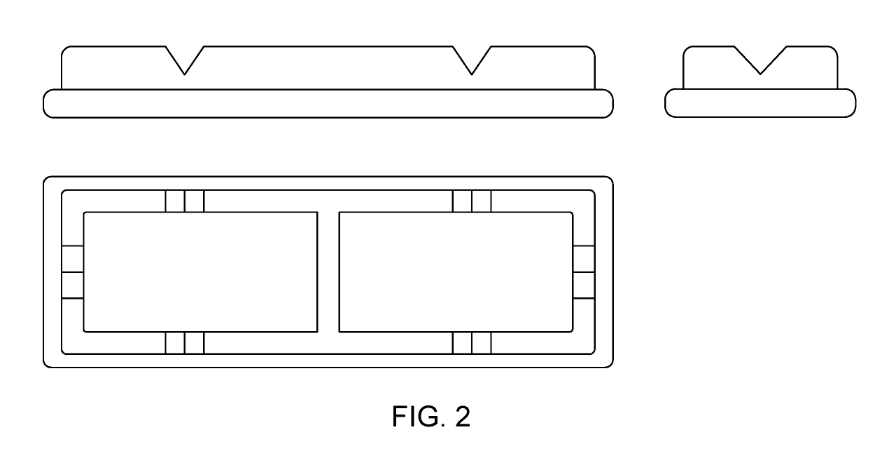

Preferred embodiments of the present invention and their advantages may be understood by referring to FIGS. 1-2, wherein like reference numerals refer to like elements.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

The terms “a”, “an” and “the” mean “one or more”, unless expressly specified otherwise.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

The present invention will now be described in detail with reference to embodiments thereof as illustrated in the accompanying drawings.

A container has at least one segment having a bottom surface and one or more sidewalls extending upward from the bottom surface. The sidewalls are generally perpendicular relative to the bottom surface. At least one sidewall has an upper perimeter with an irregular geometry where the upper perimeter is a rim of the sidewall. The irregular geometry is defined by a portion of the sidewall where the rim of the sidewall is closer to the base, relative to the remaining portions of the rim.

The irregular geometry of the rim of the sidewall may provide for a singular trough or general “V” shape. The minimum of the trough or V is the closest point on the rim to the bottom surface.

In an embodiment, the irregularly shaped portion of the rim is one or more sharpening elements disposed on a substantially exterior surface. The sharpening elements are configured to sharpen an edge of a cutting utensil. Where the irregular geometry is a V-shaped depression in the sidewall, both interior sides of the V are provided with a sharpening means. As a knife is drawn through the trough of the V, the blade contacts the sharpening means and the edge of the blade is improved during use.

In an embodiment, each of the sidewalls has a plurality of irregular shaped sections. For example, each sidewall may have multiple V-shapes into the sidewall promoting more options for the cut made by the user o the food item within the container.

In an embodiment, the bottom surface is textured. The textured is configured to promote retention of an object placed thereon. An example of the textured surface is a knurled surface. As an object, such as a food item, is place on the textured surface, projections of the texture increase the surface area contacting the food item. Further, peaks of the textured surface may positively engage or perforate an exterior of the food item when it is placed thereon. The texture may be provided in varying intensities. For example, the textured surface may provide for a spiked bottom surface.

In an embodiment, the container comprises multiple sections whereby each of the multiple sections shares a common sidewall with adjacent sections. In such an embodiment, food items placed within each section remain separated by sidewalls. Further, each of the sidewalls may have an irregular rim allowing for the cutting of food items placed within the sections.

In an alternative embodiment, the container is comprised of a material capable of withstanding high heat during cooking or microwaving of the objects retained within the container.

In another embodiment, the container has a top configured to engage the upper perimeter of the sidewalls. A perimeter of the top is adapted to sealing engage the sidewalls of the container thereby creating a seal. For example, where the sidewalls of the container have a V-shape irregularity, the top has a corresponding V-shaped projection configured to be inserted into the V-shaped irregularity of the container sidewalls.

In use, a food item is placed within the container on the bottom surface. The food item is positioned relative to an irregular section of the rim of a sidewall. The irregular section is aligned with an intended direction of a cut to be made in the food item. A user then aligns a knife or cutting tool with the irregular shape and the part of the food item to be cut, The knife is depressed within the food item and into the irregular shape of the rime. The knife is then pulled through the irregular shape and drawn against the food item. The food item is then cut where it was predetermined and the user does not have to lift the knife to reposition it for cutting as the irregular shape facilitates the transition of the knife through the cut.

Where the irregular shape has a sharpening means, the knife is drawn through the irregular shape against the cutting means and the knife edge is improved and sharpened by the sharpening means as the knife is pulled through. For example, the sharpening means may be a known grit texture or may provide for two discs overlapping a portion of one another such that the intersection of the circles creates an area to sharpen a knife. The circles may be made of a metal stronger that the blade. Each of the circles is attached to the sidewall.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. A container comprising:
a. one or more sections, wherein each of the one or more sections are defined by a bottom surface having one or more sidewalls extending upward from the bottom surface, wherein an upper perimeter of the one or more sidewalls is irregularly shaped.

2. The container of claim 1, further comprising at least two sections, wherein the at least two sections are separated by a shared sidewall.

3. The container of claim 2, wherein the one or more sections are releasably engaged with one another, wherein the shared sidewall is configured to bisect along a longitudinal axis.

4. The container of claim 3, wherein two sections of the shared sidewall releasably attach to one another using one or more magnets disposed within each of the two sections.

5. The container of claim 1, wherein the irregular shape is generally V-shaped, wherein a trough of the V-shape is proximal to the bottom surface.

6. The container of claim 5, wherein the V-shape is configured to facilitate a blade of a knife entering an interior of the container.

7. The container of claim 5, wherein each of the one or more sidewalls have a plurality of V-shape irregularities disposed at predetermined intervals of upper perimeter of each of the one or more sidewalls.
